(19) United States
(12) Patent Application Publication
(10) Pub. No.: US 2025/0002751 A1
(43) Pub. Date: Jan. 2, 2025

(54) TWO-COMPONENT AQUEOUS COATING COMPOSITION FOR WOOD BASED SUBSTRATES AND ARTICLE MADE THEREFROM

(71) Applicant: Guangdong Huarun Paints Co., Ltd., Foshan City (CN)

(72) Inventors: Yu Che, Foshan City (CN); Guijun Fan, Foshan City (CN); Zhenlin Lu, Foshan City (CN); Tingyu Hu, Foshan City (CN)

(21) Appl. No.: 18/754,240

(22) Filed: Jun. 26, 2024

(30) Foreign Application Priority Data
Jun. 27, 2023 (CN) 202310769041.6

(51) Int. Cl. C09D 175/04; B05D 7/08; C09D 5/00; C09D 7/20; C09D 7/61; C09D 7/80

(52) U.S. Cl. CPC C09D 175/04; B05D 7/08; C09D 7/20; C09D 7/80; B05D 2203/20; C09D 5/002; C09D 7/61

(57) ABSTRACT

The present disclosure relates to a two-component aqueous coating composition for wood based substrates and an article made therefrom. The aqueous coating composition includes (i) a primary agent, said primary agent including a) an aqueous polyurethane dispersion (PUD), b) an aqueous acrylic modified polyurethane (PUA), c) an aqueous liquid carrier, and d) additional additives; and ii) a curing agent composition, said curing agent composition including a hydrophilic modified aliphatic polyisocyanate, wherein a mass ratio of said primary agent to said curing agent composition is in the range of 100:5 to 100:20. The two-component aqueous coating composition of the present disclosure has a longer pot life, and a superior constructability and the coating formed therefrom has a particular excellent gloss stability.

### TECHNICAL FIELD

The present disclosure relates to an aqueous coating composition for wood based substrates. More specifically, the present disclosure relates to a high-performance two-component aqueous coating composition for wood based substrates, which is suitable for use as a sealer primer, transparent or colored primer, topcoat, solid color paint, and the like, and which is particularly suitable for being applied on the surface of a wooden substrate.

### BACKGROUND

At present, environment and energy are the two major challenges that people are facing. In order to meet this challenge, the coating industry is gradually shifting from traditional varieties of high pollution, high energy consumption, and extremely dependency on petroleum industry products to environmentally friendly and resource-saving products such as aqueous coatings, radiation curable coatings, powder coatings and high-solid coatings. With the introduction of the Chinese Chemical Industry Standard of “Indoor Water-Based Wood Coatings”, the aqueous coating composition for wooden substrate have developed rapidly. Recently, the investment in the research and development of the aqueous wood paint is increasing substantially, and correspondingly, the requirements to the aqueous wood paint are also increasing.

Current aqueous coating compositions on the market mainly include a one-component aqueous coating composition formed from a self-crosslinkable polyurethane dispersion as its main film-forming resin system, and a two-component polyurethane aqueous coating composition comprising a hydroxyl-functionalized resin and a polyisocyanate. However, the above two types of aqueous coating compositions have their own defects. For example, the one-component aqueous coating composition cannot meet the increasing requirements for paint film performance, and the two-component polyurethane aqueous coating composition is limited in its construction performance and cannot be widely promoted in practical applications.

Therefore, there is a need in the coating art to an aqueous coating composition that are particularly suitable for wooden substrates.

### SUMMARY

In one aspect, the present disclosure provides a two-component aqueous coating composition for wood-based substrates, comprising (i) a primary agent, said primary agent comprising a) an aqueous polyurethane dispersion (PUD), b) an aqueous acrylic modified polyurethane (PUA), c) an aqueous liquid carrier, and d) additional additives; and ii) a curing agent composition, said curing agent composition comprising a hydrophilic-modified aliphatic polyisocyanate, wherein a mass ratio of said primary agent to said curing agent composition is in the range of 100:5 to 100:20.

In some embodiments of the present disclosure, said curing agent composition further comprises, in addition to the hydrophilic-modified aliphatic polyisocyanate, a hydrophilic-modified alicyclic polyisocyanate and an oily aliphatic polyisocyanate. Preferably, said curing agent composition comprises, relative to the total weight of said curing agent composition, 15-25% by weight of the hydrophilic-modified aliphatic polyisocyanate, 25-35% by weight of the oily aliphatic polyisocyanate; and 45-55% by weight of the hydrophilic-modified alicylic polyisocyanate.

In some embodiments of the present disclosure, said organic solvent is present in an amount of no more than 5 wt %, relative to the total weight of said primary agent.

In one embodiment of the present disclosure, said aqueous coating composition, has an improvement of constructability of about 5%, said constructability being measured by spray applying an aqueous paint at different conditions of temperature, humidity, in particular at high temperatures (temperature above 35° C.) low humidity (humidity below 40%) conditions to form oversized workpieces, compared with a control coating composition formulated using a hydroxy-functionalized acrylate resin and the same curing agent composition.

In a preferred embodiment of the present disclosure, the aqueous coating composition formulated with a curing agent composition comprising a hydrophilic-modified aliphatic polyisocyanate, an oily aliphatic polyisocyanate and a hydrophilic-modified alicyclic polyisocyanate has, compared with the aqueous coating composition formulated with a curing agent composition comprising only a hydrophilic-modified aliphatic polyisocyanate, at least one of the following properties:
a 2-hour viscosity rise of no more than 17 units according to ASTM D1200;
a pot life extension at 35° C. of 30% or greater; and
a shorten solid drying time of 15% or greater for the same or similar surface drying time according to GB/T 1728-1989.

In another aspect, the present disclosure provides an article comprising a wood substrate having at least one primary surface; and at least one painting film, said painting film being formed from the two-component aqueous coating composition of the present disclosure, applied directly or indirectly to said primary surface. Preferably, the two-component aqueous coating composition according to the present disclosure can be used as one or all, preferably as all, of a sealing primer, a second-coat primer, a third-coat primer on the wood substrate.

It was surprisingly found by the inventors of the present disclosure that, upon formulating a two-component aqueous coating composition in which the combination of an aqueous polyurethane dispersion (PUD) and an aqueous acrylic-modified polyurethane (PUA) is compounded with a curing agent composition comprising a hydrophilic-modified aliphatic polyisocyanate, the resultant two-component coating composition is capable of obtaining a paint film with a better resistance compared with conventional self-crosslinking PUA coating compositions, while having better construction tolerance compared with a two-component polyurethane (2K PU) system.

It was further surprisingly found by the inventors of the present disclosure that upon formulating a two-component aqueous coating composition in which the combination of an aqueous polyurethane dispersion (PUD) and an aqueous acrylic-modified polyurethane (PUA) is compounded with a curing agent composition consisting of a hydrophilic-modified aliphatic polyisocyanate, an oily aliphatic polyisocyanate and a hydrophilic-modified alicyclic polyisocyanate, the resultant two-component coating compositions not only has a long pot life and the paint film formed therefrom under different drying conditions exhibits a stable gloss. Furthermore, upon formulating the two-component aqueous coating composition, controlling the amount of the organic solvent contained in the primary agent within a certain range can also significantly improve the gloss stability of the paint film, which was unforeseeable prior to the present disclosure.

The details of one or more embodiments of the present disclosure will be set forth in the description below. The other features, objectives, and advantages of the present disclosure will become apparent.

### Definition

As used herein, “a”, “an”, “the”, “at least one”, and “one or more” are used interchangeably. Thus, for example, a coating composition that comprises “an” additive can be interpreted to mean that the coating composition includes “one or more” additives.

Throughout the present disclosure, where compositions are described as having, including, or comprising specific components or fractions, or where processes are described as having, including, or comprising specific process steps, it is contemplated that the compositions or processes as disclosed herein may further comprise other components or fractions or steps, whether or not, specifically mentioned in this invention, as along as such components or steps do not affect the basic and novel characteristics of the present disclosure, but it is also contemplated that the compositions or processes may consist essentially of, or consist of, the recited components or steps.

For the sake of brevity, only certain ranges are explicitly disclosed herein. However, ranges from any lower limit may be combined with any upper limit to recite a range not explicitly recited, as well as, ranges from any lower limit may be combined with any other lower limit to recite a range not explicitly recited, in the same way, ranges from any upper limit may be combined with any other upper limit to recite a range not explicitly recited. Additionally, within a range includes every point or individual value between its end points even though not explicitly recited. Thus, every point or individual value may serve as its own lower or upper limit combined with any other point or individual value or any other lower or upper limit, to recite a range not explicitly recited.

As used herein, “or” refers to an inclusive. That is, the phrase “A or B” means “A, B, or both A and B”, which can also be abbreviated as “A and/or B”. More specifically, a condition A or B is satisfied by any one of the following: A is true (or present) and B is false (or not present); A is false (or not present) and B is true (or present); and both A and B are true (or present). In contrast, the exclusive “or” is represented herein, for example, by terms such as “either A or B” and “one of A or B”.

In the context of the present disclosure, the term “two-component aqueous coating composition” refers to a coating composition usually composed of two components, which components are packaged separately from each other, and are mixed prior to use according to the required ratio and then diluted as needed for coating to form a coating.

In the context of describing that a composition does not contain or is free of an ingredient, the phrases “does not contain” and “is free of” mean that the composition does not contain the ingredient intentionally added. Under the consideration of the complexity of components of a specific composition in the actual preparation process, the phrases “does not contain a certain component” and “is free of a certain component” can be understood to mean that the composition contains less than 1 wt. % (weight %) of the component, more preferably less than 0.5 wt. %, even more preferably less than 0.2 wt. %, most preferably less than 0.1 wt. % of the component, relative to total weight of the composition.

The term “dispersion” herein conforms to the definition in the IUPAC Compendium of Chemical Terminology (2007), which defines a dispersion to be a material comprising more than one phase, where at least one of the phases consists of finely divided phase domains, often in the colloidal size range, distributed throughout a continuous phase domain.

As used herein, the term “aqueous dispersion” refers to a dispersion in which the dispersion medium (solvent or carrier fluid) mainly or primarily contains water. For example, in some embodiments, the dispersion medium comprises at least about 50 wt. %, preferably at least about 60 wt. %, more preferably at least 70 wt. % and at most about 99 wt. % and at most about 100 wt. % of water, based on the total weight of the dispersion medium. For example, the dispersion medium comprises about 80 wt. %, about 85 wt. %, or about 95 wt. % of water, based on the total weight of the dispersion medium.

As used herein, the term “aqueous dispersion of a resin” refers to a stable dispersion of resin (i.e., polymer) in the form of particles in an aqueous liquid medium, optionally with the aid of suitable dispersion aids such as surfactants, cosolvents. Therefore, in the present disclosure, when used for polymers, unless otherwise stated, the terms “aqueous emulsion”, “aqueous latex” and “aqueous dispersion” may be used alternately. Aqueous latex may be prepared by methods known in the field, for example, by emulsion polymerization process known by technicians in this field. Aqueous dispersions are also commercially available.

As used herein, the term “hydroxyl functional” means a subject containing at least one unreacted hydroxyl functional group.

As used herein, the term “hydrophilic curing agent” has well-known meanings in the art. Generally, a hydrophilic curing agent is usually obtained by hydrophilic modification of a curing agent. The hydrophilic curing agent can be, for example, non-ionic type hydrophilic-modified (for example, Bayhydur 3100 available from Covestro), ionic type modified, or non-ionic type and ionic type composite modified.

Working time or useable life or pot life is the time within which, once the mutually reactive components of a coating composition have been mixed, the coating composition may still be properly processed or applied and coatings of unimpaired quality can be achieved. The handling of two-component coating compositions generally requires mixing together the reactive components shortly before application to avoid premature reaction of the reactive components. The term “shortly before application” is well-known to a person skilled in the art working with two-component coating compositions. The time period within which the ready-to-use coating composition may be prepared prior to the actual use/application depends, e.g., on the pot life of the coating composition. Therefore, a sufficient long pot life is desired in order to have a comfortable time window for preparing/mixing and applying the two-component coating compositions. Thus, working time may also be defined as the amount of time for a coating to reach the required performance. In general, at the end of the working time, the viscosity of the coating will significantly increase, even reach 2 times to its original viscosity. In addition, due to the differences between water-based resin and oil-based resin, viscosity alone cannot be used as the only standard to determine the working time. For an aqueous dispersion, the transparency, fullness, gloss and hardness of the film cannot be significantly reduced at the end of the workable time.

As used herein, the term “cured” means that the condition of a liquid composition in which an applied film of the composition is at least set-to-touch as defined in ASTM D 5895-Standard Test Methods for Evaluating Drying or Curing During Film Formation of Organic Coatings Using Mechanical Recorder, which is hereby incorporated herein by reference. As used herein, “cure” and “curing” refer to the progression of an applied liquid composition from the liquid state to a cured state. The terms “cured”, “cure”, and “curing” encompass drying of compositions through solvent evaporation and chemical crosslinking of components in compositions.

As used herein, the term “constructability” refers to a parameter used to measure the ease of construction of a coating composition, which is measured by spray applying an aqueous paint at different conditions of temperature, humidity, in particular at high temperature (temperature above 35° C.) and low humidity (humidity below 40%) conditions to form oversized workpieces. Usually, the parameter of constructability is rated by construction personnel, generally divided into 1-5 levels, the higher the level, the better the constructability, of which, level 1 indicates the worst constructability; level 5 indicates the optimal constructability; and level 3 indicates a very poor state of constructability, basically without meeting the commercial requirements. The drop of 5% in the level of constructability means that the deterioration of the constructability is already significant to the naked eye.

In the context of the present disclosure, ‘gloss stability’ is a parameter used to measure the application of the coating composition, which is measured by the difference between the gloss of the coating (defined as the 60-degree gloss measured by GB 1743-1979(1989)) formed from the coating composition applied at room temperature (25° C.) and the gloss of the coating formed from the coating composition applied at 50° C. The greater the difference in gloss, the poorer the gloss stability of the coating, while the smaller the difference in gloss, the superior the gloss stability of the coating.

As used herein, the term “primer” refers to a coating composition that can be directly applied to a substrate and dried, crosslinked, or otherwise hardened to form a non-sticky continuous film with sufficient adhesion on the surface of the substrate, which continuous film can have a certain protective effect on the surface of the substrate.

As used herein, the term “topcoat” refers to a coating composition that can be directly applied to a substrate or a primer and dried, crosslinked, or otherwise hardened to form a non-sticky continuous film with sufficient adhesion on the surface of the substrate or primer, which continuous film can have a certain protective effect on the surface of the substrate or primer and also have a decorative effect.

The terms “preferred” and “preferably” refer to embodiments of the present disclosure that may afford certain benefits, under certain circumstances. However, other embodiments may also be preferred, under the same or other circumstances. Furthermore, the recitation of one or more preferred embodiments does not imply that other embodiments are not useful, and is not intended to exclude other embodiments from the scope of the present disclosure.

### DETAILED DESCRIPTION

According to the first aspect of the present disclosure, a two-component aqueous coating composition for wood-based substrates is provided, which comprises (i) a primary agent, said primary agent comprising a) an aqueous polyurethane dispersion (PUD), b) an aqueous acrylic modified polyurethane (PUA), c) an aqueous liquid carrier, and d) additional additives; and ii) a curing agent composition, said curing agent composition comprising a hydrophilic-modified aliphatic polyisocyanate, wherein a mass ratio of said primary agent to said curing agent composition is in the range of 100:5 to 100:20.

### Primary Agent(s)

According to embodiments of the present disclosure, the primary agent comprises aqueous polyurethane dispersions (PUD), i.e. aqueous dispersions formed from polyurethane polymer particles and aqueous acrylic-modified polyurethanes (PUA), i.e. aqueous dispersions formed from acrylic-modified polyurethane polymer particles. As described in the definition, the aqueous dispersion can be prepared by emulsion polymerization and can therefore also be referred to simply as ‘aqueous latex’. In the present disclosure, the polymer particles can be modified by, for example, organic functional groups (including, but not limited to, carboxyl groups, hydroxyl groups, amino groups, sulfonate groups, and the like) to obtain aqueous latexes with desired properties. Thus, in the present disclosure, the aqueous polyurethane dispersion (PUD) is a dispersion of unmodified polyurethane polymer particles in an aqueous medium, and the aqueous acrylic-modified polyurethane (PUA) is a dispersion of polyurethane polymer particles that have been modified by acrylic (ester) organic functional groups in an aqueous medium.

In some embodiments according to the present disclosure, said aqueous polyurethane dispersion (PUD) comprises carboxyl functional groups, preferably having an acid value of from 5 to 20 mg KOH/g according to ASTM D1639; and/or, said aqueous polyurethane dispersion (PUD) has a hydroxyl value of from 0 to 45 mg KOH/g according to ASTM E222-65T, which is significantly lower than that of the hydroxyl-functionalized film-forming polymer resins commercially available on the market.

In some embodiments according to the present disclosure, said aqueous acrylic modified polyurethane (PUA) comprises carboxyl functional groups, preferably having an acid value of from 5 to 20 mg KOH/g according to ASTM D1639; and/or, said aqueous acrylic modified polyurethane (PUA) has a hydroxyl value of from 0 to 50 mg KOH/g according to ASTM E222-65T, which is significantly lower than that of the hydroxyl-functionalized film-forming polymer resins commercially available on the market.

It is well known that the primary agent system composed of an aqueous polyurethane dispersion (PUD) and/or an aqueous acrylic modified polyurethane (PUA) is a one-component system, which is capable of forming a film without the addition of a curing agent, and the primary agent in such a one-component system is more conducive to fusion and cross-linking of resin particles in the process of forming a film, compared with a two-component system comprising a hydroxyl-functionalized resins for which a curing agent is required to form a film well. It was surprisingly found by the inventors of the present disclosure that the two-component aqueous coating compositions according to the present disclosure formed with an aqueous polyurethane dispersion (PUD) and/or an aqueous acrylic-modified polyurethane (PUA) system as a primary agent taken in combination with a curing agent possessed significantly better constructability than the two-component coating compositions comprising a dispersion of hydroxyl functionalized acrylics.

Without being bound by any theory, the inventors speculate that when a hydroxyl-functionalized resin is mixed with a polyisocyanate curing agent, the NCO functional group in the curing agent basically reacts with the hydroxyl group with a higher activity and thus the reaction proceeds very fast. On the contrary, in the aqueous coating composition according to the present disclosure, the aqueous polyurethane dispersion (PUD) and/or the aqueous acrylic-modified polyurethane (PUA) used as a primary agent have a low hydroxyl value according to ASTM E222-65T, and have a certain acid value according to ASTM D1639, so that when they are mixed with the polyisocyanate curing agent, the NCO in the curing agent reacts not only with the hydroxyl group, but also with the carboxyl group in the resin, and thus the reaction rate is appropriately adjusted, and thus the aqueous coating composition so formulated exhibits superior constructability.

Preferably, in the two-component coating composition according to the present disclosure, the amount of the aqueous polyurethane dispersion (PUD) can be adjusted as desired. For example it can be present in an amount in the range of 15 to 65 wt %, preferably in the range of 20 to 55 wt %, relative to the total weight of the primary agent.

Preferably, in the two-component coating composition according to the present disclosure, the amount of the aqueous acrylic-modified polyurethane (PUA) can be adjusted as desired. For example, it can be present in an amount in the range of 5 to 60 wt %, preferably in the range of 15 to 55 wt %, relative to the total weight of the primary agent.

In some embodiments according to the present disclosure, the primary agent in the two-component coating composition according to the present disclosure does not contain an aqueous dispersion of hydroxyl-functional acrylic polymers, and preferably does not contain any other hydroxyl-functional resin. As described above, the phrase ‘the primary agent is free of an aqueous dispersion of hydroxyl-functional acrylic polymers’ means that the primary agent does not contain an aqueous dispersion of hydroxyl functional acrylic polymer intentionally added. However, in view of the complexity of the specific composition of the components during the actual formulation process, the phrase ‘the primary agent is substantially free of an aqueous dispersion of hydroxyl-functional acrylic polymers’ can be regarded as the fact that the primary agent comprises an aqueous dispersion of hydroxyl functional acrylic polymers in an amount of less than 1 wt. %, more preferably less than 0.5 wt. %, even more preferably less than 0.2 wt %, most preferably less than 0.1 wt %, based on the total weight of the primary agent.

In the context according to the present disclosure, hydroxyl functional acrylic polymers have the meaning known in the art. In one embodiment of the present disclosure, the hydroxyl-functional acrylic polymers can be an emulsion polymerized latex polymer, the aqueous dispersion of which is prepared by an emulsion polymerization, and which may thus be referred to simply as ‘aqueous latex’. Methods for preparing aqueous latexes are known in the art. For example, the aqueous latexes can be prepared using an emulsion polymerization process known to those skilled in the art. In another embodiment of the present disclosure, the hydroxyl functional acrylic polymers can be organic solution polymerized acrylic polymers, the aqueous dispersion of which is obtained by re-dispersing the polymers so made in water. Methods of preparing acrylic acid polymers using an organic solution polymerization are known in the art. For example, the polymers can be prepared using a solution polymerization process known to those skilled in the art.

The hydroxyl-functionalized acrylic polymers typically have a relatively high hydroxyl value. The hydroxyl value is usually expressed as the amount in milligrams of potassium hydroxide (KOH) equivalent to the hydroxyl content per gram of the hydroxyl-containing substance and measured according to ASTM E222-65T. According to the present disclosure, the hydroxyl-functionalized acrylic polymer has a hydroxyl value of at least 60 mg KOH/g polymer according to ASTM E222-65T, more preferably at least 70 mg KOH/g polymer according to ASTM E222-65T, still more preferably at least 80 mg KOH/g polymer according to ASTM E222-65T, but preferably the hydroxyl value does not exceed 200 mg KOH/g polymer according to ASTM E222-65T.

The hydroxyl-containing acrylic polymer in the aqueous dispersion according to the present disclosure may be any type of acrylic polymer, including acrylates polymers, styrene-acrylates polymers, silicone-modified acrylates polymers, urethane-modified acrylates polymers or combinations thereof.

In some embodiments according to the present disclosure, the primary agent in the two-component coating composition according to the present disclosure comprises an amount of an aqueous liquid carrier. Suitable aqueous liquid carriers include organic solvents, water and mixtures thereof. The aqueous liquid carrier is selected so as to adjust viscosity of the primary agent for use in further formulation.

Suitable organic solvents include alcohols (such as ethanol, n-propanol, isopropanol, n-butanol, isobutanol, and the like); ketones (such as acetone, 2-butanone, cyclohexanone, methyl aryl ketone, ethyl aryl ketone, methyl isoamyl ketone, and the like); glycols (such as butyl glycol); glycol ethers (such as ethylene glycol monomethyl ether, ethylene glycol monoethyl ether, ethylene glycol monobutyl ether, propylene glycol monomethyl ether, methoxypropanol, dipropylene glycol methyl ether, and the like), glycol esters (such as butyl glycol acetate, methoxypropyl acetate and the like); and its mixtures.

The amount of aqueous liquid carrier included in the primary agent may vary, for example, depending on the application method and the desired viscosity (according to ASTM D1200). Preferred embodiments of the primary agent comprise 5-20 wt % of an aqueous liquid carrier, more preferably 8-15 wt % of an aqueous liquid carrier.

It is surprisingly found by the inventors of the present disclosure that, upon formulating a two-component aqueous coating composition, the gloss stability of the resultant paint film can also be significantly enhanced by controlling the amount of organic solvents contained in the primary agent within a certain range. Accordingly, in a preferred embodiment of the present disclosure, the organic solvent is present in the primary agent in an amount of not more than 5 wt %, preferably not more than 3.5 wt %, and more preferably not more than 2.5 wt %, relative to the total weight of said primary agent.

If necessary, in the coating composition according to the present disclosure, the primary agent may optionally contain other additives, which do not adversely affect the coating composition or the cured coating obtained therefrom. Appropriate additives include, for example, those that can improve the processing or manufacturing properties of the composition, enhance the aesthetics of the composition, or improve the specific functional properties or characteristics of the coating composition or the cured composition obtained therefrom, such as adhesion to the substrate. The additives that can be included are additional polymers, emulsifiers, pigments, metal powders or pastes, fillers such as titanium dioxide, anti-migration aids, anti-bacterial agents, extenders, lubricants, coagulants, wetting agents, biocides agents, plasticizers, defoamers, colorants, waxes, antioxidants, corrosion inhibitors, flow control agents, thixotropic agents, dispersants, UV stabilizers, scavengers, or combinations thereof. The content of each optional component is sufficient to achieve its intended purpose, but preferably, such content does not adversely affect the coating composition or the cured coating obtained therefrom.

In one embodiment of the present disclosure, the primary agent comprises, relative to the total weight of said primary agent, from 0 to 35 wt %, preferably from 3 to 30 wt %, of additional additives. Preferably, said additional additive comprises one or more of a dispersant, titanium dioxide, other additional additives mentioned above.

### Curing Agent Composition

According to the present disclosure, the aqueous coating composition comprises a curing agent composition to enhance the performance of a paint film with PUD and/or PUA as its film-forming resin, wherein said curing agent composition comprises a hydrophilic-modified aliphatic polyisocyanate. Hydrophilic curing agents are typically obtained by hydrophilic modification of a curing agent, as described above. In embodiments of the present disclosure, the curing agent composition comprises a hydrophilic-modified aliphatic polyisocyanate. By way of exemplary illustration, said hydrophilic-modified aliphatic polyisocyanate is selected from hydrophilic-modified hexamethylene diisocyanate, hydrophilic-modified trimethyl hexamethylene diisocyanate and combinations thereof, and preferably from hydrophilic-modified hexamethylene diisocyanate.

In the present disclosure, the hydrophilic-modified aliphatic polyisocyanate may be prepared by suitable methods known to one of ordinary skill in the art, or any suitable commercially available product may be used as an example, such as WANHUA 268, HUAGOSHAN HOUXIAN 200L, KUANZHI OS-9012, COSTINSTRON bayhydur 305, BURNOCK DNW-5500, or a combination thereof.

In addition to the above hydrophilic-modified aliphatic polyisocyanates, the curing agent compositions may further comprise hydrophilic-modified alicyclic polyisocyanates and oily aliphatic polyisocyanates.

It was found by the inventors of the present disclosure that upon formulating a two-component aqueous coating composition, a curing agent composition comprising a hydrophilic-modified aliphatic polyisocyanate, an oily aliphatic polyisocyanate, and a hydrophilic-modified alicyclic polyisocyanate can significantly improve the curing performance of the aqueous coating composition compared with those curing agent composition comprising only a hydrophilic-modified aliphatic polyisocyanate. Compared with a single hydrophilic-modified aliphatic polyisocyanate (such as HDI) as a curing agent, hybrid curing agents have the following advantages: the alicyclic polyisocyanate (such as IPDI) due to its rigid structure can reduce the chances of collision between the primary agent and the curing agent after they are mixed, thus contributing to improving a pot life of the system; at the same time, although more solvents are introduced by the hybrid curing agent composition, the IPDI, due to its structural characteristics, is favorable for build-up of an initial hardness, and therefore did not affect its surface drying time. The addition of an oily curing agent helps to increase the cross-linking density during film formation, which in turn helps to improve the solid drying time of the film as well as the cross-linking density after film formation. At the same time, the hybrid curing agent comprises a certain amount of the hydrophilic-modified aliphatic polyisocyanate to ensure its dispersion performance in the primary agent without affecting the construction of this hybrid system. Therefore, in the formulation of the aqueous coating composition according to the present disclosure, a combination of a hydrophilic-modified aliphatic polyisocyanate, an oily aliphatic polyisocyanate, and a hydrophilic-modified alicyclic polyisocyanate as a curing agent composition is particularly excellent for enhancing the curing performance of the resultant coating.

In addition, it was found by the inventors of the present disclosure that the use of a combination of hydrophilic-modified aliphatic polyisocyanates, oily aliphatic polyisocyanates and hydrophilic-modified alicyclic polyisocyanates as a curing agent composition in a primary agent in which PUA and/PUD are used further enhances the gloss stability of the resultant coating compared with the use of a single hydrophilic-modified aliphatic polyisocyanate as a curing agent composition, which would have been difficult to anticipate prior to the present disclosure.

In some embodiments according to the present disclosure, said oily aliphatic polyisocyanates comprise oily hexamethylene diisocyanate, oily trimethyl hexamethylene diisocyanate and combinations thereof, preferably oily hexamethylene diisocyanate. In the present disclosure, the oily aliphatic polyisocyanates may be prepared by suitable methods known to those of ordinary skill in the art, or any suitable commercially available product may be used as an example, such as Covestro DESMODUR N 3600, Covestro DESMODUR N 3300, Covestro DESMODUR N 3900, or combinations thereof.

In some embodiments according to the present disclosure, the hydrophilic-modified alicyclic polyisocyanate is selected from hydrophilic-modified isophorone diisocyanate, hydrophilic-modified dicyclohexylmethane diisocyanate, hydrophilic-modified cyclohexane dimethyldiisocyanate, and combinations thereof, preferably from hydrophilic-modified isophorone diisocyanate. In the present disclosure, the hydrophilic-modified alicyclic polyisocyanates may be prepared by suitable methods known to those of ordinary skill in the art, or any suitable commercially available product may be used as an example, such as Covestro BAYHYDUR 401-70, Covestro BAYHYDUR 401-60 or combinations thereof.

In a preferred embodiment according to the present disclosure, said curing agent composition comprises, relative to the total weight of said curing agent composition,
15-25 wt % of a hydrophilic modified aliphatic polyisocyanate;
25-35 wt % of an oily aliphatic polyisocyanate; and
45-55 wt % of a hydrophilic modified alicyclic polyisocyanates.

According to the present disclosure, the two-component aqueous coating composition can be prepared by simply mixing the primary agent and the curing agent composition in a mixing device at a predetermined weight ratio, preferably at a weight ratio of 100:5 to 100:20 before application. During the application process, the obtained mixture is mixed with a certain amount of inert diluent to obtain a coating composition that meets the application requirements.

The resulting coating composition can be applied in a variety of ways that are familiar to those skilled in the art, including spraying (e.g., air assisted, airless or electrostatic spraying), brushing, rolling, flooding and dipping. In an embodiment of the present disclosure, the resulting coating composition is coated by spraying. The coating composition can be applied in various wet film thickness. In an embodiment of the present disclosure, the coating composition is applied in such a wet film thickness that the formed coating has a dry thickness preferably from about 13 to about 260 m (about 0.5 to about 10 mils) and more preferably from about 25 to about 75 m (about 1 to about 3 mils). The applied coating may be cured by air drying or by accelerating drying with various drying devices (e.g., ovens) that are familiar to those skilled in the art.

In one embodiment according to the present disclosure, the aqueous coating composition, has an improvement of constructability of about 5%, said constructability being measured by spray applying an aqueous paint at different conditions of temperature, humidity, in particular at high temperatures (temperature above 35° C.) and low humidity (humidity below 40%) conditions to form oversized workpieces, compared with a control coating composition formulated using a hydroxyl functional acrylate resin and the same curing agent composition.

In one embodiment according to the present disclosure, the aqueous coating composition formulated with a curing agent composition comprising a hydrophilic modified aliphatic polyisocyanate, an oily aliphatic polyisocyanate and a hydrophilic modified alicyclic polyisocyanate has, compared with the aqueous coating composition formulated with a curing agent composition comprising only a hydrophilic modified aliphatic polyisocyanate, at least one of the following properties:
a 2-hours viscosity rise of no more than 17 units according to ASTM D1200;
a pot life extension at 35° C. of 30% or greater; and
a shorten solid drying time of 15% or greater for the same or similar surface drying time according to GB/T 1728-1989.

Thus, the two-component coating composition according to the present disclosure has a wide range of applications, and can be used as a sealing primer, a transparent primer, a topcoat, a solid color paint, and the like. Therefore, the present disclosure also relates to a wooden article, which comprises a wooden substrate having at least one main surface; and one or more paint films formed from the two-component aqueous coating composition according to the present disclosure which is directly or indirectly coated on the main surface. In some embodiments, the two-component aqueous coating composition of the present disclosure can be coated on a wooden substrate as one or more, preferably all, of a primer, a topcoat.

As the wooden substrate used to manufacture the wooden article of the present disclosure, any suitable wooden substrate known in the art can be used. In the present disclosure, the term “wooden substrate” refers to any material of cellulose/lignin derived from the hard, fibrous structural tissue in the stems and roots of trees or other woody plants. Wood includes, for example, hardwood and softwood lumber directly cut from trees, as well as engineered wood composites made from strands, particles, fibers or veneers of wood. Examples of wood composites include, but are not limited to, plywood, oriented strand board (OSB), medium-density fiberboard (MDF), particle boards, and the like.

As an exemplary wooden substrate, one or more of hardwood, chestnut, oak, red hook chestnut, camellia, press wood, Douglas fir, Japanese cedar, American cypress, Japanese red pine, Japanese cypress, water walnut, black walnut, maple, Japanese beech, Japanese paulownia, birch, Salina, magnolia, ash, teak, oak, catalpa, camphor wood, fir, oak, and rubber wood may be used.

According to the present disclosure, the wood article thus obtained can be used for the following applications, including, but not limited to: household furniture, such as tables, chairs, cabinets, and the like; bedroom and bathroom furniture; office furniture; custom furniture, such as school and children's furniture, hospitals furniture, restaurant and hotel furniture, kitchen cabinets and furniture; panels for interior design; indoor and outdoor windows and doors; indoor and outdoor window and door frames; outdoor and indoor wall panels and wooden floors.

### Examples

The present disclosure is more particularly described in the following examples that are intended as illustrations only, since numerous modifications and variations within the scope of the present disclosure will be apparent to those skilled in the art. Unless otherwise noted, all parts, percentages, and ratios reported in the following examples are on a weight basis, and all reagents used in the examples are commercially available and used directly without further treatment.

### Test Methods

Unless otherwise stated, the following test methods are used in the examples.

Constructability refers to a parameter used to measure the ease of construction of a coating composition, which is rated by construction personnel by spray applying an aqueous paint at different conditions of temperature, humidity, in particular at high temperature (temperature above 35° C.) and low humidity (humidity below 40%) conditions to form oversized workpieces. It is divided into 1-5 levels, the higher the level, the better the constructability in which level 1 indicates the worst constructability; level 5 indicates the optimal constructability; and level 3 indicates a very poor state of constructability, basically without meeting the commercial requirements. The drop of 5% in the level of constructability means that the deterioration of the constructability is already significant to the naked eye.

Pot life refers to the period of time during which the viscosity of a mixture may reach 2 times its initial viscosity at 35° C. after mixing the primary agent and the curing agent composition to obtain the resultant mixture, in which the viscosity is the viscosity measured of the 4-cup test according to ASTM D1200.

Surface drying time and solid drying time: are determined according to GB/T 1728-1989.

Gloss: is determined according to GB 1743-1979(1989).

### Material

The raw materials used in each example are listed below.
Aqueous polyurethane dispersion (PUD): NeoRez R-2180, commercially available from DSM, with an acid value of 5 to 20 mg KOH/g according to ASTM D1639 and a hydroxyl value of 0 to 45 mg KOH/g according to ASTM E222-65T;
Aqueous acrylic-modified polyurethane (PUA): Neopac E-129, commercially available from DSM, with an acid value of 5 to 20 mg KOH/g according to ASTM D1639 and a hydroxyl value of 0 to 50 mg KOH/g according to ASTM E222-65T;
Hydrophilic-modified HDI: BayhydurXP2655, commercially purchased from Covestro;
Oily HDI: DESMODUR N 3600, commercially available from Covestro;
Hydrophilic modified IPDI: BAYHYDUR 401-60, commercially available from Covestro;
Organic solvents: alcohols, general industrial products;
Dispersant: general industrial products;
Titanium dioxide: general industrial products;
Other auxiliaries: general industrial products
Hydroxyl functional acrylic resin: Houxian 2006 commercially purchased from Houxian, with a hydroxyl value of 120 mgKOH/g according to ASTM E222-65T.

### Coating Compositions

An aqueous polyurethane dispersion (PUD), an aqueous acrylic-modified polyurethane (PUA), an alcohol, water, a dispersant, a titanium dioxide, and other additives in the amounts shown in Table 1 below were added to a mixing vessel and mixed, and then stirred at 800-1000 rpm homogeneous, thereby obtaining a primary agent. The primary agent thus prepared was mixed with a curing agent composition in a weight ratio of 100:10 and the coating composition was determined.

TABLE 1
The composition of the aqueous coating composition

| | | | | | | | | | Control |
|---|---|---|---|---|---|---|---|---|---|
| | | CEx. 1 | Ex. 1 | Ex. 2 | Ex. 3 | Ex. 4 | Ex. 5 | Ex. 6 | Example |
| Primary agent | PUD | — | — | 55 | 32 | 32 | 32 | 32 | 40 |
| | PUA | — | 55 | — | 23 | 23 | 23 | 23 | 15 |
| | Hydroxyl functional acrylate | 55 | — | — | — | — | — | — | — |
| | Organic solvent | 3.7 | 3.7 | 3.7 | 3.7 | 3.7 | 3.2 | 2.1 | 3.0 |
| | Water | 10.9 | 10.9 | 10.9 | 10.9 | 10.9 | 10.9 | 12.5 | 11.6 |
| | Dispersant | 1.5 | 1.5 | 1.5 | 1.5 | 1.5 | 1.5 | 1.5 | 1.5 |
| | Titanium Dioxide | 21 | 21 | 21 | 21 | 21 | 21 | 21 | 21 |
| | Other additives | 7.9 | 7.9 | 7.9 | 7.9 | 7.9 | 7.9 | 7.9 | 7.9 |
| | Total | 100 | 100 | 100 | 100 | 100 | 100 | 100 | 100 |
| Curing agent | Hydrophilic HDI | 2 | 10 | 10 | 10 | 2 | 2 | 2 | — |
| composition | Oily HDI | 3 | — | — | — | 3 | 3 | 3 | — |
| | Hydrophilic IPDI | 5 | — | — | — | 5 | 5 | 5 | — |
| | Total | 10 | 10 | 10 | 10 | 10 | 10 | 10 | — |

Note:
Comparative Example 1 is a two-component coating composition comprising hydroxyl acrylate and a curing agent composition and Control Example is a one-component coating composition without a curing agent; Examples 1, 2 and 3 are examples comprising PUD, PUA and a combination of the two, respectively; Example 3 is distinguishable from Example 4 by its curing agent in which a single curing agent is used in Example 3 and a mixed curing agent is used in Example 4; and Examples 4-6 are examples with varying organic solvent content.

1. Matching a Curing Agent with Different Primary Agents:

Systems with different primary agent paired with a curing agent were compared in which the standard sample was PUA/PUD as a primary agent paired with a mixed curing agent, and the comparative sample was a hydroxyl acrylic dispersion as a primary agent paired with the same curing agent, and the comparative tests were conducted by spraying them on a panel under the same conditions. The results are shown below:

TABLE 2

Test Results

| Items | Example 3 | Comparative Example 1 |
|---|---|---|
| Constructability | 4.8 | 3.5 |
| Scratch resistance | 4 | 3 |
| Scrap resistance | 4.8 | 4.6 |

From the test results, the PUA/PUD system as a primary agent has better constructability than the hydroxyl acrylic dispersion system. Theoretically, the primary agent of PUA/PUD system is a one-component system, which system can be film-forming without curing agent, compared with the two-component system for which a curing agent is required to form a good film, and thus such one component system will be more conducive to fusion and crosslinking of resin particles in the film-forming process. After the addition of a curing agent, the reaction rate between NCO and carboxyl will be less than that between NCO and hydroxyl, so the resultant mixture will exhibit significantly improved constructability, and the presence of the curing agent as a relatively small molecule will enable the resultant coating from the one-component system to have a better film-forming effect, which is conducive to the enhancement of the resistances to scratches and scuffing. Therefore, the combination of such one-component system with a curing agent is better, both in terms of constructability and film-forming properties.

### 2. Comparison of One-Component and Two-Component Systems

1K coating composition just comprising PUA/PUD as resins of the primary agent without a curing agent (Control Example) and 2K coating compositions comprising PUA/PUD as resins of the primary agent paired with a hydrophilic-modified HDI as a curing agent (Examples 1 and 2) were compared and tested for their resistance according to GB/T 23999-2009. The results were summarized in the following Table 3.

TABLE 3

| Examples | Acid resistance | Acid resistance | Alcohol resistance | Water resistance |
|---|---|---|---|---|
| Control Example | No visible change | No visible change | Whitening, not recovered within 1 hour | Significant whitening, not |
| | | | | recovered within 1 hour |
| Example 1 | No visible change | No visible change | Slight whitening, recovered within 1 hour | No visible change |
| Example 2 | No visible change | No visible change | Slight whitening, recovered within 1 hour | No visible change |

In the 2K system, a hydrophilic modified HDI was used as a curing agent, and a ratio of the primary agent to the curing agent was 100:10. As can be seen, the addition of the curing agent to the one-component system can significantly improve the chemical resistance of the resultant paint film. Theoretically, the addition of curing agent makes the cross-linking density increase obviously, NCO not only reacts with the residual hydroxyl group in the system, but also can react with the carboxyl group, which can help the three-dimensional network construction of the cross-linking system and improve the cross-linking density of the system.

3. Matching a Primary Agent with Different Curing Agents

A single curing agent and a mixed curing agent were paired with the primary agent to test the properties of the coating compositions and the resulting coatings, respectively. The test results were summarized in Table 4 below.

TABLE 4

| | | Δ Viscosity rise | Surface | Solid | Pendulum |
|---|---|---|---|---|---|
| | Pot life@35° | @2 hrs/unit | drying | drying | hardness |
| Examples | C./h (V0 = 65 s) | (V0 = 65 s) | time/min | time/min | after 3 days/s |
| Example 3 | 3 | 22.34 | 20 | 30 | 88.3 |
| Example 4 | 4 | 10.06 | 20 | 25 | 96.3 |

In Example 3, the primary agent of PUA/PUD resin system was paired with a single curing agent of hydrophilic modified HDI, while in Example 4, the same resin system was paired with a mixture of three different types of curing agents, in which the three types of curing agents were hydrophilic modified HDI, oily HDI, and hydrophilic modified IPDI, at a ratio of 2:3:5. The total amount of the curing agent was 10, and a ratio of the primary agent and the curing agent was 100:10. Prior to use, the curing agent was diluted 1:1 with water.

The results showed that the system with a mixed three-types of curing agent exhibited the following characteristics compared with the system with only one type of curing agent:
(a) The resulting two-component system had an extended pot life. Particularly, when the initial viscosity as measured by ASTM D1200 was adjusted to 65 s, the pot life tested at 35° C. was extended from 3 h to 4 h;
(b) The rate of viscosity increase was slow down. Particularly, the percentage of viscosity rise in 2 hours decreased from 22.34 units to 10.06 units; and
(c) The solid drying was speeded up with the same surface drying.

Theoretically, the hybrid curing agent has the following advantages over a single hydrophilic modified HDI as a curing agent:

IPDI due to its rigid structure reduces the chances of collision between the primary agent and the curing agent after they are mixed, thus contributing to improving a pot life of the system. At the same time, although more solvents are introduced by the hybrid curing agent composition, the IPDI, due to its structural characteristics, is favorable for build-up of an initial hardness, and therefore does not affect its surface drying time. The addition of an oily curing agent helps to increase the cross-linking density during film formation, which in turn helps to improve the solid drying time of the film as well as the cross-linking density after film formation. Meanwhile, the hybrid curing agent comprises a certain amount of the hydrophilic-modified HDI to ensure its dispersion performance in the primary agent without affecting the construction of this hybrid system. In addition, compared with those systems of a hybrid curing agent matching with a hydroxyl-containing primary agent in other patents, the system of the hybrid curing agent matching with one-component primary agent according to the present disclosure does not need to consider the specific ratio of NCO to hydroxyl, and can achieve better results than one-component system by mixing a primary agent, curing agent and water at a ratio of 100:10:10 commonly used in the conventional aqueous two-component PU systems. Therefore, matching a hybrid curing agent with one-component PUA/PUD resin system as a primary agent can achieve the best performance and price.

4. Effect of Solvent Concentration on the Systems with the Main Agent Matching Different Curing Agents

The samples of Examples 3-6 were applied by spraying, with a coating volume of 100 g/m². All samples dried at room temperature were placed in an environment with a relative humidity of 80% and a temperature of 25° C. overnight drying, and all samples dried at 50° C. were placed in an oven at 50° C. overnight. Then, each sample was determined for its gloss and the results were summarized in Table 5 below.

TABLE 5

| | Example | Example | Example | Example |
|---|---|---|---|---|
| | 3 | 4 | 5 | 6 |
| Gloss @room | 38.2 | 40.4 | 35.5 | 36.3 |
| temperature | | | | |
| Gloss@50° C. | 27.2 | 30.8 | 29.3 | 30.6 |
| Change in gloss | 11 | 9.6 | 6.2 | 5.7 |

Comparison of Example 3 with Example 4 showed reduction in gloss change, indicating that the use of a hybrid curing agent is more effective in stabilizing the gloss compared with the use of a purely aqueous HDI type curing agent. Comparing Examples 4-6, it can be shown that reducing the solvent content in the primary agent further helps to stabilize the gloss when a hybrid curing agent is added.

The following embodiments are contemplated. All combinations of features and embodiments are contemplated.

Embodiment 1. A two-component aqueous coating composition for wood-based substrates, comprising
(i) a primary agent, said primary agent comprising
   a) an aqueous polyurethane dispersion (PUD),
   b) an aqueous acrylic modified polyurethane (PUA),
   c) an aqueous liquid carrier, and
   d) additional additives;
ii) a curing agent composition, said curing agent composition comprising a hydrophilic modified aliphatic polyisocyanate,
wherein a mass ratio of said primary agent to said curing agent composition is in the range of 100:5 to 100:20.

Embodiment 2. The aqueous coating composition as claimed in Embodiment 1, wherein said curing agent composition further comprises a hydrophilic modified alicyclic polyisocyanate and an oily aliphatic polyisocyanate.

Embodiment 3. The aqueous coating composition as claimed in Embodiment 2, wherein said curing agent composition comprises, relative to the total weight of said curing agent composition
15-25% by weight of the hydrophilic modified aliphatic polyisocyanate
25-35% by weight of the oily aliphatic polyisocyanate; and
45-55% by weight of the hydrophilic modified alicylic polyisocyanate.

Embodiment 4. The aqueous coating composition as claimed in any one of Embodiments 1 to 3, wherein said hydrophilic modified aliphatic polyisocyanate is selected from hydrophilic modified hexane diisocyanate, hydrophilic modified trimethyl hexane diisocyanate and combinations thereof, preferably selected from hydrophilic modified hexane diisocyanate.

Embodiment 5. The aqueous coating composition as claimed in any one of Embodiments 2 to 3, wherein said oily aliphatic polyisocyanate comprises oily hexane diisocyanate, oily trimethyl hexane diisocyanate and combinations thereof, preferably selected from oily hexane diisocyanate.

Embodiment 6. The aqueous coating composition as claimed in any one of Embodiments 2 to 3, wherein said hydrophilic modified alicyclic polyisocyanate is selected from hydrophilic modified isophorone diisocyanate, hydrophilic modified dicyclohexylmethane diisocyanate, hydrophilic modified cyclohexane dimethyl diisocyanate and combinations thereof, preferably from hydrophilic modified isophorone diisocyanate.

Embodiment 7. The aqueous coating composition as claimed in Embodiment 1, wherein said aqueous polyurethane dispersion (PUD) comprises a carboxyl functional group, preferably having an acid value of 5 to 20 mg KOH/g according to ASTM D1639; and/or, said aqueous polyurethane dispersion (PUD) has a hydroxyl value of 0 to 45 mg KOH/g according to ASTM E222-65T.

Embodiment 8. The aqueous coating composition as claimed in Embodiment 1, wherein said aqueous acrylic modified polyurethane (PUA) comprises a carboxyl functional group, preferably having an acid value of 5 to 20 mg KOH/g according to ASTM D1639; and/or, said aqueous acrylic modified polyurethane (PUA) having a hydroxyl value of 0 to 50 mg KOH/g according to ASTM E222-65T.

Embodiment 9. The aqueous coating composition as claimed in any one of Embodiments 1 to 8, wherein said aqueous coating composition is free of other hydroxyl-functionalized resins.

Embodiment 10. The aqueous coating composition as claimed in any one of Embodiments 1 to 8, wherein said primary agent comprises, with respect to the total weight of said primary agent
15 to 65% by weight of an aqueous polyurethane dispersion (PUD), preferably 20 to 55% by weight of an aqueous polyurethane dispersion (PUD)
5 to 60% by weight of an aqueous acrylic-modified polyurethane (PUA), preferably 15 to 55% by weight of an aqueous acrylic-modified polyurethane (PUA)
5 to 20% by weight of an aqueous liquid carrier, preferably from 8 to 15% by weight of an aqueous liquid carrier; and
0 to 35% by weight of additional additives, preferably 0.5 to 30% by weight of additional additives.

Embodiment 11. The aqueous coating composition as claimed in any one of Embodiments 1 to 8, wherein said aqueous liquid carrier comprises water, an organic solvent or a combination thereof.

Embodiment 12. The aqueous coating composition as claimed in any one of Embodiments 1 to 8, wherein said organic solvent is present in an amount of no more than 5 wt %, preferably no more than 3.5 wt %, more preferably no more than 2.5 wt %, relative to the total weight of said primary agent.

Embodiment 13. The aqueous coating composition as claimed in any one of Embodiments 1 to 12, wherein said aqueous coating composition, has an improvement of constructability of about 5%, said constructability being measured by spray applying an aqueous paint at different conditions of temperature, humidity, in particular at high temperatures (temperature above 35° C.) low humidity (humidity below 40%) conditions to form oversized workpieces, compared to a control coating composition formulated using a hydroxy-functionalized acrylate resin and the same curing agent composition.

Embodiment 14. The aqueous coating composition as claimed in any one of Embodiments 12, wherein the aqueous coating composition formulated with a curing agent composition comprising a hydrophilic modified aliphatic polyisocyanate, an oily aliphatic polyisocyanate and a hydrophilic modified alicyclic polyisocyanate has, compared to the aqueous coating composition formulated with a curing agent composition comprising only a hydrophilic modified aliphatic polyisocyanate, at least one of the following properties:
a 2-hour viscosity rise of no more than 17 units according to ASTM D1200;
a pot life extension at 35° C. of 30% or greater; and
a shorten solid drying time of 15% or greater for the same or similar surface drying time according to GB/T 1728-1989.

Embodiment 15. An article comprising
a wood substrate having at least one primary surface; and
at least one painting film, said painting film being formed by the two-component aqueous coating composition as claimed in any one of Embodiments 1 to 14, applied directly or indirectly to said primary surface.

While the present disclosure has been described with respect to a number of embodiments and examples, those skilled in the art, having benefit of this disclosure, will appreciate that other embodiments can be devised which do not depart from the scope and spirit of the present disclosure as disclosed herein.

What is claimed is:

1. A two-component aqueous coating composition for wood-based substrates, comprising
(i) a primary agent, said primary agent comprising
a) an aqueous polyurethane dispersion (PUD),
b) an aqueous acrylic modified polyurethane (PUA),
c) an aqueous liquid carrier, and
d) additional additives;
ii) a curing agent composition, said curing agent composition comprising a hydrophilic modified aliphatic polyisocyanate,
wherein a mass ratio of said primary agent to said curing agent composition is in the range of 100:5 to 100:20.

2. The aqueous coating composition as claimed in claim 1, wherein said curing agent composition further comprises a hydrophilic modified alicyclic polyisocyanate and an oily aliphatic polyisocyanate.

3. The aqueous coating composition as claimed in claim 2, wherein said curing agent composition comprises, relative to the total weight of said curing agent composition
15-25% by weight of the hydrophilic modified aliphatic polyisocyanate
25-35% by weight of the oily aliphatic polyisocyanate; and
45-55% by weight of the hydrophilic modified alicylic polyisocyanate.

4. The aqueous coating composition as claimed in claim 1, wherein said hydrophilic modified aliphatic polyisocyanate is selected from hydrophilic modified hexane diisocyanate, hydrophilic modified trimethyl hexane diisocyanate and combinations thereof, preferably selected from hydrophilic modified hexane diisocyanate.

5. The aqueous coating composition as claimed in claim 2, wherein said oily aliphatic polyisocyanate comprises oily hexane diisocyanate, oily trimethyl hexane diisocyanate and combinations thereof, preferably selected from oily hexane diisocyanate.

6. The aqueous coating composition as claimed in claim 2, wherein said hydrophilic modified alicyclic polyisocyanate is selected from hydrophilic modified isophorone diisocyanate, hydrophilic modified dicyclohexylmethane diisocyanate, hydrophilic modified cyclohexane dimethyl diisocyanate and combinations thereof, preferably from hydrophilic modified isophorone diisocyanate.

7. The aqueous coating composition as claimed in claim 1, wherein said aqueous polyurethane dispersion (PUD) comprises a carboxyl functional group, preferably having an acid value of 5 to 20 mg KOH/g according to ASTM D1639; and/or, said aqueous polyurethane dispersion (PUD) has a hydroxyl value of 0 to 45 mg KOH/g according to ASTM E222-65T.

8. The aqueous coating composition as claimed in claim 1, wherein said aqueous acrylic modified polyurethane (PUA) comprises a carboxyl functional group, preferably having an acid value of 5 to 20 mg KOH/g according to ASTM D1639; and/or, said aqueous acrylic modified polyurethane (PUA) having a hydroxyl value of 0 to 50 mg KOH/g according to ASTM E222-65T.

9. The aqueous coating composition as claimed in claim 1, wherein said aqueous coating composition is free of other hydroxyl-functionalized resins.

10. The aqueous coating composition as claimed in claim 1, wherein said primary agent comprises, with respect to the total weight of said primary agent
15 to 65% by weight of an aqueous polyurethane dispersion (PUD), preferably 20 to 55% by weight of an aqueous polyurethane dispersion (PUD)
5 to 60% by weight of an aqueous acrylic-modified polyurethane (PUA), preferably 15 to 55% by weight of an aqueous acrylic-modified polyurethane (PUA)
5 to 20% by weight of an aqueous liquid carrier, preferably from 8 to 15% by weight of an aqueous liquid carrier; and
0 to 35% by weight of additional additives, preferably 0.5 to 30% by weight of additional additives.

11. The aqueous coating composition as claimed in claim 1, wherein said aqueous liquid carrier comprises water, an organic solvent or a combination thereof.

12. The aqueous coating composition as claimed in claim 1, wherein said organic solvent is present in an amount of no more than 5 wt %, preferably no more than 3.5 wt %, more preferably no more than 2.5 wt %, relative to the total weight of said primary agent.

13. The aqueous coating composition as claimed in claim 1, wherein said aqueous coating composition, has an improvement of constructability of about 5%, said constructability being measured by spray applying an aqueous paint at different conditions of temperature, humidity, in particular at high temperatures (temperature above 35° C.) low humidity (humidity below 40%) conditions to form oversized workpieces, compared to a control coating composition formulated using a hydroxy-functionalized acrylate resin and the same curing agent composition.

14. The aqueous coating composition as claimed in claim 1, wherein the aqueous coating composition formulated with a curing agent composition comprising a hydrophilic modified aliphatic polyisocyanate, an oily aliphatic polyisocyanate and a hydrophilic modified alicyclic polyisocyanate has, compared to the aqueous coating composition formulated with a curing agent composition comprising only a hydrophilic modified aliphatic polyisocyanate, at least one of the following properties:
a 2-hour viscosity rise of no more than 17 units according to ASTM D1200;
a pot life extension at 35° C. of 30% or greater; and
a shorten solid drying time of 15% or greater for the same or similar surface drying time according to GB/T 1728-1989.

15. An article comprising
a wood substrate having at least one primary surface; and
at least one painting film, said painting film being formed by the two-component aqueous coating composition as claimed in claim 1, applied directly or indirectly to said primary surface.
